(19) United States
(12) Patent Application Publication
(10) Pub. No.: US 2014/0280447 A1
(43) Pub. Date: Sep. 18, 2014

(54) METHOD AND APPARATUS FOR PROVIDING CLOUD SERVICE

(71) Applicant: Samsung Electronics Co., Ltd., Gyeonggi-do (KR)

(72) Inventor: Jae Gon Kim, Gyeonggi-do (KR)

(21) Appl. No.: 14/353,927

(22) PCT Filed: Oct. 22, 2012
(86) PCT No.: PCT/KR2012/008647

§ 371 Date: Apr. 24, 2014

(30) Foreign Application Priority Data
Oct. 24, 2011 (KR) 10-2011-0108698

(51) Int. Cl. H04L 29/08

(52) U.S. Cl. CPC H04L 67/10
USPC 709/201

(57) ABSTRACT

A method of receiving a cloud service in a mobile device is provided, which includes executing a mobile application; creating a mobile code; transmitting the created mobile code to a mobile code execution server; interrupting the execution of the mobile application; receiving a request for re-executing the application from the mobile code execution server; and re-executing the mobile application.

### PRIORITY

This application is a National Phase Entry of PCT International Application No. PCT/KR2012/008647, which was filed Oct. 22, 2012, and claims priority to Korean Patent Application No. 10-2011-0108698 filed on Oct. 24, 2011, the entire content of which is incorporated herein by reference.

### BACKGROUND

1. Field of the Invention

The present invention generally relates to a method and an apparatus for providing a cloud service.

2. Description of the Related Art

A cloud service provides a service of Information Technology (IT) resources using an Internet technology, and allows a user to borrow the IT resources as much as the user wants. An expansion and a contraction of the amount for use can be made in real time according to a service load, and the cost is charged depending on the amount of use. “Cloud” refers to an Internet base. That is, the cloud is the Internet, and it means an infrastructure. The cloud is a service by which IT related functions, such as a word processing activity, an e-mail service and a server management, are used through a typical computing operation, and may be utilized as a service only through the Internet without an equipment of hardware because all of the information is stored on the Internet. When using a cloud service, even though computer data is lost due to viruses or physical failures, an e-mail and data may remain safe, and enterprises may use all of the typical IT resources only through the Internet without high-performance Personal Computers (PCs) and mass storage devices. The cloud service, which is installed in a data center, transmits applications, hardware and system software through the Internet. Information is permanently stored in a server on the Internet and is temporarily stored in clients such as desktop PCs, tablet computers, notebooks, wall-mounted computers, and portable devices.

Mobile cloud computing is a technology in which a cloud computing technology is introduced to mobile computing in order to cope with limitations of mobile devices that have limited resources. The cloud computing is a computing service by which a user borrows computing resources, such as hardware and software, in an intangible form like cloud, as much as the user wants to use, and the usage fee may be charged depending on the amount of use. Also, the cloud computing is a computing paradigm that integrates and provides resources of computers in different physical locations by means of virtual technology. In the environment of the mobile cloud computing, it is required to reduce power consumption of a mobile device, network traffic and the amount of use of computing resources, and protect a user's position information.

FIG. 1 is a flowchart illustrating a general method of requesting and transmitting large files. A mobile device 110 requests transmission of a large file from a cloud storage server 124 in step 101, and then the cloud storage server 124 transmits a large file corresponding to the request to the mobile device 110 in step 103. At this time, the large file incurs a transmission burden on a network. Problems of this method include large file storage space is depleted and a battery is drained for processing the large file in the mobile device 110.

FIG. 2 is a flowchart illustrating a general method of requesting a cloud service.

A mobile device 110 requests transmission of a service from a cloud web service server 126 in step 201, and then the cloud web service server 126 transmits a service corresponding to the request to the mobile device 110 in step 203. The steps 201 and 203 are repeatedly performed. The above method has a problem including a battery is drained due to repeated requests for transmission of a service and reception of a service.

FIG. 3 is a flowchart illustrating a general method of requesting and transmitting a Location Based Service (LBS).

A mobile device 110 requests an LBS from a cloud LBS server in step 301, and then the cloud LBS server provides the LBS corresponding to the request to the mobile device 110 in step 305. At this time, as shown in step 303, the cloud LBS server has a problem including position information of the mobile device 110 is exposed.

FIG. 4 is a flowchart illustrating a general method of requesting and transmitting an image/movie service.

A search engine 150 requests transmission of an image/movie from a cloud storage server 124 in step 401, and then the cloud storage server 124 transmits the image/movie corresponding to the request to the search engine 150 in step 403. Subsequently, the search engine 150 extracts a characteristic value from the transmitted image/movie in step 405, and compares the extracted characteristic value with a pre-stored characteristic value in step 407.

FIG. 5 is a flowchart illustrating a general method of requesting and transmitting of a characteristic value.

A cloud storage server 124 extracts a characteristic value from a stored image/movie in step 501. The search engine 150 requests transmission of a characteristic value from the cloud storage server 124 in step 503, and then the cloud storage server 124 transmits a characteristic value corresponding to the request to the search engine 150 in step 505. Subsequently, the search engine 150 compares the characteristic value with a pre-stored characteristic value in step 507. The above method is limited by storage space for images/movies.

A computing environment on a mobile device such as a smart phone has disadvantages as follows:
(1) a limited capacity of a battery;
(2) a high cost of wireless network data transmission;
(3) an increase of a demand for privacy protection of a mobile device user;
(4) limited computing resources (e.g., the amount of use of a CPU, a memory size and a storage space size).

A mobile device is limited for operations of the following applications due to the above-described disadvantages:
(1) an application which requires transmission of large files: network resources of a high cost used for transmission of large data and a limited storage space;
(2) a monitoring-based application: an application operated in a background, continuously uses a CPU resource and performs a periodic network connection, which results in depletion of a battery due to a continuous use of a CPU and an increase of a cost due to a continuous use of a network;
(3) an application which requires a high computing power: depletion of a battery and limited performance of a CPU due to a use of a CPU for a long time;
(4) an application which exposes position information of a mobile device: infringement of privacy and a misuse of position information due to exposure of personal position information.

The current cloud storage service is applied to a mobile computing service (e.g., Apple iCloud, Daum Cloud, or the like) in order to overcome the limitations of limited computing resources, particularly, the limitation of a limited storage space to be used in data synchronization/sharing between devices in a multi device environment.

In addition, the limitations related to limited computing resources in mobile devices are being gradually diminished by, for example, introduction and spread of multi core processors in mobile devices such as smart phones and tablet PCs.

However, since, for the purpose of processing data stored in the cloud storage, the data is transmitted to the mobile device and processed using a CPU of the mobile device, the cloud storage service also has a limitation including a network cost generated in transmitting large files and depletion of a battery used for processing data.

Also, the typical mobile cloud computing is vulnerable to applications which require a high computing power and monitoring-based applications which continuously use a CPU resource and perform a periodic network connection (e.g., a controversy about Kakao Talk of SKT that causes traffic). Moreover, the typical mobile cloud computing has a drawback in exposing position information of a mobile device (e.g., a controversy about the recording of position information by Apple).

### SUMMARY

The present invention has been made to address at least the above-mentioned problems and/or disadvantages and to provide at least the advantages described below. Accordingly, an aspect of the present invention provides a method and an apparatus which can reduce power consumption of a mobile device, network traffic and the amount of use of computing resources in the environment of mobile cloud computing.

Another aspect of the present invention provides a method and an apparatus which can prevent position information of a mobile device from being exposed in the environment of mobile cloud computing. In accordance with an aspect of the present invention, a method, executed in a mobile device, of receiving a cloud service includes when a mobile application is executed, creating a mobile code; transmitting the created mobile code to a mobile code execution server; interrupting the execution of the mobile application; receiving a request for re-execution of the application from the mobile code execution server; and re-executing the mobile application, wherein the mobile code is executed to be an agent. In accordance with another aspect of the present invention, a method, executed in a mobile code execution server, of providing a cloud service includes receiving a mobile code from a mobile device; executing the mobile code; transmitting a request for a service to a cloud server based on the result of the execution of the mobile code; receiving a result of the service from the cloud server; transmitting a request for re-execution of a mobile application to the mobile device; and transmitting the result of the service to the mobile device, wherein the mobile code is executed to be an agent.

In accordance with another aspect of the present invention, an apparatus, executed in a mobile device, for receiving a cloud service includes a mobile code creation unit that, when a mobile application is executed, creates a mobile code; a transmission unit that transmits the created mobile code to a mobile code execution server; a controller that interrupts the execution of the mobile application, and, when a request for re-execution of the application is received from the mobile code execution server, re-executes the mobile application; and a receiving unit that receives the request for re-execution of the application from the mobile code execution server, wherein the mobile code is executed to be an agent.

In accordance with another aspect of the present invention, an apparatus, in a mobile code execution server, for providing a cloud service includes a receiving unit that receives a mobile code from a mobile device, and receives a result of a requested service from a cloud server; a controller that executes the mobile code; and a transmission unit that transmits a request for a service to the cloud server, and transmits a request for re-execution of a mobile application to the mobile device, and transmits the result of the service to the mobile device, wherein the mobile code is executed to be an agent.

### BRIEF DESCRIPTION OF THE DRAWING

The above and other aspects, features, and advantages of the present invention will be more apparent from the following detailed description taken in conjunction with the accompanying drawings, in which:

FIG. 1 is a flowchart illustrating a general method of requesting and transmitting large files;

FIG. 2 is a flowchart illustrating a general method of requesting and transmitting a cloud service;

FIG. 3 is a flowchart illustrating a general method of requesting and transmitting a Location Based Service (LBS);

FIG. 4 is a flowchart illustrating a general method of requesting and transmitting an image/movie service;

FIG. 5 is a flowchart illustrating a general method of requesting and transmitting a characteristic value;

FIG. 6 illustrates a mobile cloud computing environment to which the present invention is applied;

FIGS. 7A to 7E illustrate a method of providing a cloud service according to an embodiment of the present invention;

FIGS. 8A and 8B illustrate a cloud service method according to a first embodiment of the present invention;

FIGS. 9A to 9C illustrate a cloud service method according to a second embodiment of the present invention;

FIGS. 10A to 10D illustrate a cloud service method according to a third embodiment of the present invention;

FIGS. 11A and 11B illustrate a cloud service method according to a fourth embodiment of the present invention;

FIGS. 12A to 12F illustrate a cloud service method according to a fifth embodiment of the present invention;

FIGS. 13A and 13B illustrate a cloud service method to which a general contents based information search service is applied;

FIGS. 14A and 14B illustrate a cloud service method according to a sixth embodiment of the present invention;

FIG. 15 is a flowchart illustrating an operation according to an embodiment of the present invention; and

FIG. 16 is a flowchart illustrating an operation according to another embodiment of the present invention.

### DETAILED DESCRIPTION OF EMBODIMENTS OF THE PRESENT INVENTION

Hereinafter, the detailed description of embodiments of the present invention will be described in detail with reference to the accompanying drawings. It should be noted that identical elements of the drawings consequently bear the same reference numerals through all of the drawings.

Also, in the following description, although numerous specific and particular details are set forth, they are provided in order to help with a thorough understanding of the present invention. It will be obvious to those skilled in the art that the present invention may be implemented without these specific details. In addition, in describing the present invention, the detailed description of well-known functions and configurations will be omitted so as not to make the scope of the present invention unclear.

In the following detailed description, names, which are defined in the telecommunication standards applied with a mobile cloud computing environment, will be used in the present invention in order to address the above-described technical problems, but these standards and names are not intended to restrict the scope of the present invention, which may be applied to systems of a similar technical background.

The present invention reduces network traffic, power consumption of a mobile device and the amount of use of a CPU, which result from transmission of large files to mobile devices.

The present invention reduces power consumption of a mobile device and network traffic, which are generated by a mobile application that is executed in a background to continuously connect to a network.

The present invention reduces power consumption and the amount of use of a CPU, which are generated by a mobile application that performs calculation using CPU for a long time.

The present invention provides a Location Based Service (LBS) without direct exposure of position information of a mobile device to an LBS server, so that a user's position information may be protected.

The present invention provides a service by which an application is automatically installed instead of voluntary installation by a user in a hoppin service, so that the user's convenience may be enhanced.

The present invention reduces a cost of a network for transmitting a large file in a contents based search for movies/pictures.

The present invention reduces power consumption of a mobile device, network traffic and the amount of use of computing resources, and protects position information of a user by applying the following ideas to the mobile cloud computing.

FIG. 6 illustrates a mobile cloud computing environment to which the present invention is applied. A method of providing a cloud service according to an embodiment of the present invention, to which the mobile cloud computing environment of FIG. 6 is applied, will be described with reference to FIGS. 7A to 7E.

Referring to FIGS. 6 and 7A, an application of a mobile device 110 located in a wireless network creates a mobile code, and the created mobile code is transmitted to a mobile code execution server 120. The transmitted mobile code is executed by an agent dispatcher 122 as an agent.

In terms of a code mobility, transmitting and processing an execution code when a large amount of data exists will incur a network cost less than receiving and processing the large amount of data.

The agent temporarily interrupts the execution of the application in the mobile device, and allows an agent program executed in another server in a cloud to perform a process instead. That is, the role of processing the application is handed over, which can save a battery, network traffic and mobile device computing resources.

The cloud computing environment includes a cloud storage server 124 that provides a cloud storage service to devices and a cloud web server 126 that provides various cloud web services.

The mobile device 110 manages the mobile code execution server 120 to protect personal information and determine whether personal information can be trusted in a cloud environment. The mobile device 110 and the mobile code execution server 120 are connected with each other by a wireless network or a wired network. The mobile device 110 operates software of an application dispatcher 115, and the mobile code execution server 120 operates software of the agent dispatcher 122.

The agent dispatcher 122 operated in the mobile code execution server 120 executes the mobile code received through a network to operate as an agent. Referring to FIG. 7B, when a mobile code is transmitted, an ID of a mobile device that transmits the mobile code, and an ID of a mobile application creating an agent are transmitted together, which are used as an agent ID. An application in the mobile device 110 creates the mobile code, and then the mobile application is interrupted as shown in FIG. 7C.

As shown in FIG. 7D, when the mobile device 110 receives an application resume push message from the network, the interrupted application is re-executed.

The mobile code execution server 120 extracts the mobile device ID from the agent ID in order to recognize the mobile device to which the application resume push message will be transmitted, and communicates with the mobile device 110. The mobile code execution server 120 transmits the agent ID together with the application resume push message to the mobile device 110. The application dispatcher 115 extracts the mobile application ID from the agent ID and determines which mobile application is to be re-executed.

Referring to FIG. 7E, when the mobile application is re-executed by the application dispatcher 115, the agent transmits an execution result or an event to the mobile application of the mobile device 110 through a message. The application of the mobile device 110 provides a service to a user using the received execution result.

FIGS. 8A and 8B illustrate a cloud service method according to a first embodiment of the present invention. The first embodiment of the present invention describes a case to which a data preprocessing application is applied.

Referring to FIG. 8A, a mobile application, which uses a large file received from a cloud storage, transmits an agent to a mobile code execution server 120 to be executed. The agent preprocesses data in the cloud storage to generate processed small data.

Referring to FIG. 8B, the agent transmits the preprocessed small data to the mobile application, and then the mobile application provides a service to a user using the data.

With the above method, the network traffic used for transmission of large files can be reduced, and a CPU resource and a battery used for preproceing a large file can be saved. This processing method may be utilized for a movie encoding service.

FIGS. 9A to 9C illustrate a cloud service method according to a second embodiment of the present invention. The second embodiment of the present invention will describe a case to which a location based application is applied without exposure of position information. Referring to FIG. 9A, a mobile application (e.g., LBS application), which uses a location based service by providing position information to a LBS provider 160, transmits an agent to a mobile code execution server 120 to be executed. At this time, the mobile code execution server 120 (e.g., servers of a trusted computing service provider by which personal information can be protected, or hosting PCs/cloud servers which legally protect personal information pursuant to a personal contract) is located in a personal area of a mobile device owner.

A mobile device 110, referring to FIG. 9B, transmits location information 900, about the place where a user wants a service to be provided, to a mobile agent in order to get an LBS. At this time, the location information includes, for example, latitude and longitude information. The latitude and longitude information of FIG. 9B denotes, for example, Samsung Electronics, Suwon, Gyeonggi-do, Korea. The mobile agent requests an LBS for a large region (e.g., Suwon, Gyeonggi-do, Korea) information 902, by which it is hard to identify position information of the mobile device, from the LBS provider 160. The LBS provider 160 provides an LBS for the large region (e.g., Suwon, Gyeonggi-do, Korea) to the mobile agent. The mobile agent transmits only LBS information 903 related to the place (e.g., Samsung Electronics, Suwon, Gyeonggi-do, Korea) requested by the mobile device from the received LBS information for the large region (e.g., Suwon, Gyeonggi-do, Korea) to the mobile device as shown in FIG. 9C.

By utilizing this method, since the mobile device does not directly receive an LBS related to a region, a network cost for receiving a large amount of data may be saved.

In addition, the present invention can provide an LBS without regard to a limitation of a mobile device having a limited processing ability and a memory capacity, preventing position information of a mobile device from being exposed to a LBS provider. That is, the LBS may be provided without exposure of position information of a mobile device to the LBS provider.

FIGS. 10A to 10D illustrate a cloud service method according to a third embodiment of the present invention. The third embodiment of the present invention will describe a case to which a background execution/monitoring application (e.g., a background execution status messenger, e-mail/stock/auction information monitoring, and home network monitoring) is applied.

A mobile application, as shown in FIG. 10A, transmits an agent to a mobile code execution server 120 to be executed. The mobile application, which continuously uses a network and performs monitoring, stops its own execution as shown in FIG. 10A. The agent operated in the mobile code execution server is executed in a background to perform a monitoring operation on behalf of the mobile application as shown in FIG. 10B. The agent connects to various servers using a wired network for collecting and processing desired data, and checking whether a certain event is generated.

When an event requiring the operation of the mobile application is generated, the agent transmits a push message to the mobile device 110 to thereby re-execute the mobile application, and transfers the corresponding event to the mobile application through a message, as shown in FIGS. 10C and 10D. The mobile application that receives the event performs an operation corresponding to the event to thereby provide a service to a user.

By utilizing the above method, battery depletion generated when the mobile application is executed in a background in the mobile device can be reduced, and network traffic generated by the continuous monitoring can be reduced. Applications, to which this processing method can be applied, include various messenger applications which operate in a background to continuously check status information of a user, Social Networking Service (SNS) applications which continuously connect to a server to check an on-line connection, e-mail clients which periodically connect to a server to receive e-mails, stock/auction applications which periodically connect to a server to receive price information, and home network system monitoring applications which continuously connect to various home appliances at home to monitor status information of the various home appliances.

FIGS. 11A and 11B illustrate a cloud service method according to a fourth embodiment of the present invention. The fourth embodiment of the present invention describes a high scientific calculation service (e.g., grid computing).

A mobile application, which performs a high scientific calculation (e.g., a calculation that requires computing for a long time) using a large amount of data located in a cloud storage, transmits an agent to a mobile code execution server 120 to be executed as shown in FIG. 11A. The agent accesses the large amount of data in the cloud storage and performs a high scientific calculation. After calculation, the agent re-executes the application of the mobile device and transmits a calculation result.

The mobile application to perform a high scientific calculation executes agents with respect to several mobile code execution servers 120 as shown in FIG. 11B. The mobile application splits a calculation area into several parts that are to be transmitted to each of the agents. The agents each calculate the split areas in parallel. After calculation, each of the agents transmits an execution result to the mobile application.

By using this method, the large use of a CPU resource and depletion of battery, which are generated when the mobile application performs computing for a long time for a high scientific calculation, can be prevented.

FIGS. 12A to 12F illustrate a cloud service method according to a fifth embodiment of the present invention. The fifth embodiment of the present invention describes a hoppin service (e.g., automaticity/user's convenience) that provides a service in a multi device environment. Here, the hoppin service is a multi-screen service available for a variety of Video On Demand (VOD) contents such as TV programs, films, dramas, animations on a smart phone, tablet, or PC. Applications, to which the fifth embodiment of the present invention is applied, include movie editing mobile applications, terminal connection mobile applications, scheduler applications, or the like.

The hoppin service provides a multimedia service at any time transmitted to screens of various digital devices such as PCs, TVs and smart phones. The typical hoppin service is provided in such a manner that applications providing the hoppin service are installed in the mobile devices in advance and connect to a cloud storage to provide the multimedia service. The hoppin service can be applied to a number of applications used by a user regardless of the kind of multimedia by using a mobile code and an agent. A mobile agent follows a user who switches from one device to the other device in using multiple devices to provide a service as shown in FIG. 12A.

Referring to FIG. 12B, a user who has used a mobile application in a mobile device A moves to a smart TV in order to use the application in a larger screen.

As shown in FIG. 12C, the smart TV that detects the user's movement from the mobile device transmits a request for an agent movement to the mobile application of the mobile device A.

As shown in FIG. 12D, the mobile application creates a user's operation status up to the present time together with a mobile code.

As shown in FIG. 12E, the mobile device A transmits the created mobile code and the operation status to the smart TV.

As shown in FIG. 12F, the agent starts using the mobile code transmitted to the smart TV, and the transmitted status information is applied to the agent to allow the user to successively do the same operation in the smart TV as that of the mobile device A.

By utilizing the above method, a user does not have to separately install applications into each of devices he/she possesses because the applications are automatically installed therein, and a user can successively do the operation that he/she has done immediately before the switch of the devices because operation contents are automatically transmitted to another device, which may enhance the user's convenience. The above method may be applied to movie editing applications supporting a user's movement, terminal applications supporting a user movement, and scheduler applications supporting a user movement.

FIGS. 13A and 13B illustrate a general contents based information search (e.g., a movie/image search or a non-text base search) service.

A contents based information search service is provided in such a manner that a user takes a photo of something he/she wants to know about and requests information of the photo from a search engine, and then a search result corresponding to the photo is displayed in a mobile device (i.e., a terminal).

Referring to FIG. 13A, when a search engine 150 requests an image/movie from a cloud storage server 124, the cloud storage server 124 transmits the image/movie corresponding to the request to the mobile device 110. Subsequently, the mobile device 110 extracts a characteristic value from the transmitted image/movie, and compares the extracted characteristic value with a pre-stored characteristic value. The above method is limited by a network image/movie storage space of the search engine. Also, the network under such usage may be overloaded.

Referring to FIG. 13B, the cloud storage server 124 extracts a characteristic value from an image/movie stored therein. When the search engine 150 requests a characteristic value from the cloud storage server 124, the cloud storage server 124 transmits the characteristic value corresponding to the request to the search engine 150. Subsequently, the search engine 150 compares the transmitted characteristic value with a pre-stored characteristic value. The above method has problems of incompatibility of a characteristic value extraction algorithm between the cloud storage services and poor performance of a characteristic value extraction algorithm of a fixed cloud storage service.

FIGS. 14A and 14B illustrate a cloud service method according to a sixth embodiment of the present invention. The sixth embodiment of the present invention will describe a contents based information search (e.g., a movie/image search, or a non-text base search). The sixth embodiment of the present invention may be applied to a national CCTV search for a criminal investigation, and a CCTV based traffic measurement system, for an example of the contents based information search service.

The contents base information search is a technology of searching for real material in the contents, unlike a typical text based tag search. When movies/images need to be searched for, the typical text based tag search performs a search using file names of the movies/images, while the contents based information search searches for objects, scenes and colors contained in the movies/images. According to this characteristic of a search function, files should be transmitted to search for contents for a performance of the contents search. Utilization of the mobile code and the agent can reduce the cost of a network use resulting from the above operation.

As shown in FIG. 14A, a search engine 150 performing a contents based search transmits a mobile code to servers, which have databases of movies/images, to be executed.

As shown in FIG. 14B, the transmitted mobile code is executed as an agent, and an cloud storage server 124 locally performs the contents based search to transmit the result to the search engine 150. Then, the search engine 150 compares a transmitted characteristic value with a characteristic value of a query picture, and informs the mobile device 110 of the search result.

By utilizing this method, a problem of a limitation of a storage space generated upon downloads of images/movies to the search engine can be overcome. Also, by utilizing this method, a contents based search can be performed without incurring a large network load due to copying of files of movies/images to the search engine for the contents based search. This contents based search method may be applied to a CCTV search for a criminal investigation, and a CCTV base traffic measurement system.

FIG. 15 is a flowchart illustrating an operation according to an embodiment of the present invention. The flowchart of FIG. 15 may be applied to the first and the second embodiments of the present invention. A mobile device 110 executes a mobile application in step 1501, and creates a mobile code in step 1502. Subsequently, the mobile device 110 transmits the created mobile code to a mobile code execution server 120 in step 1503, and interrupts the execution of the mobile application in step 1504. Meanwhile, the mobile code execution server 120 receives the mobile mode from the mobile device 110 in step 1505 to thereby execute the mobile code in step 1506, and requests a service from a cloud server in step 1507. The cloud server receives the request for a service from the mobile code execution server 120 in step 1508, and processes the requested service in step 1509 to thereby transmit a service result corresponding to the request to the mobile code execution server 120 in step 1510. The mobile code execution server 120 receives the service result from the cloud server in step 1511. The mobile code execution server 120 determines whether transmission of a request for a service is repeated in step 1512. If the service transmission is repeated, it returns to the step 1507. If the service transmission is not repeated, the mobile code execution server 120 transmits a request for re-execution of the mobile application to the mobile device 110 in step 1513. Meanwhile, the mobile device 110 receives the request for re-execution of the mobile application from the mobile code execution server 120 in step 1514, and re-executes the mobile application in step 1515. Meanwhile, the mobile code execution server 120 transmits the service result received from the cloud server to the mobile device 110 in step 1516. Then, the mobile device 110 receives the service result from the mobile code execution server 120 in step 1517, and provides a corresponding service to a user in step 1518

FIG. 16 is a flowchart illustrating an operation according to another embodiment of the present invention. The flowchart of FIG. 16 may be applied to the sixth embodiment of the present invention.

A search engine 150 creates a mobile code for extraction of a characteristic value in step 1601, and transmits the mobile code for extraction of a characteristic value to a cloud storage server 124 in step 1602. Then, the cloud storage server 124 receives the mobile code for extraction of a characteristic value in step 1603, and executes the mobile code in step 1604. Subsequently, the cloud storage server 124 extracts a characteristic value from images/movies stored in the cloud storage server 124 in step 1605, and transmits the extracted characteristic value to the mobile device 110 in step 1606. Meanwhile, the search engine 150 receives the characteristic value from the cloud storage server 124 in step 1607, and compares the transmitted characteristic value with a characteristic value of a query picture in step 1608 to thereby inform the mobile device 110 of a search result.

Although not shown in the drawings, the mobile device may include, but is not limited to, a mobile code creation unit that creates a mobile code, a transmission unit that transmits the created mobile code to a mobile code execution server, a controller that interrupts the execution of the mobile application, when the mobile code is transmitted to the mobile code execution server, and re-executes the mobile application, when a request for re-execution of the mobile application is received, and a receiving unit that receives the request for re-execution of the mobile application from the mobile code execution server.

Although not illustrated in the drawings, the mobile code execution server may include, but is not limited to, a receiving unit that receives a mobile code from a mobile device and receives a requested service result from a cloud server, a controller that executes the mobile code, and a transmission unit that transmits a request for a service to the cloud server, transmits a request for re-execution of a mobile application to the mobile device, and transmits the service result to the mobile device.

Meanwhile, although specific embodiments are described in the detailed description of the present invention, it will be obvious that various modifications may be made without departing from the scope of the present invention. Accodingly, the scope of the present invention should not be restricted to the described embodiments, but should be decided by the appended clams and equivalents to the claims as well.

1. A method, executed in a mobile device, of receiving a cloud service, the method comprising:
when a mobile application is executed, creating a mobile code;
transmitting the created mobile code to a mobile code execution server;
interrupting the execution of the mobile application;
receiving a request for re-execution of the application from the mobile code execution server; and
re-executing the mobile application,
wherein the mobile code is executed as an agent.

2. (canceled)

3. The method as claimed in claim 1, wherein with regard to the mobile code, an ID of the mobile device that transmits the mobile code, and an ID of an mobile application that creates the agent are transmitted together from the mobile device to the mobile code execution server.

4. The method as claimed in claim 1, wherein the mobile code allows the mobile code execution server to generate a small file from a large file located in a cloud storage on behalf of the mobile device.

5. The method as claimed in claim 1, wherein the mobile code allows the mobile code execution server to provide a location based service on behalf of the mobile device.

6. The method as claimed in claim 1, wherein the mobile code allows the mobile code execution server to be executed as a background to thereby-perform a monitoring operation on behalf of the mobile device.

7. The method as claimed in claim 1, wherein the mobile code allows the mobile code execution server to perform a contents based search and extraction of a characteristic value on behalf of the mobile device.

8. An apparatus, in a mobile device, for receiving a cloud service, the apparatus comprising:
a mobile code creation unit configured to, when a mobile application is executed, creates a mobile code;
a transmission unit configured to transmits the created mobile code to a mobile code execution server;
a controller configured to interrupts the execution of the mobile application, and, when a request for re-execution of the application is received from the mobile code execution server, to re-executes the mobile application; and
a receiving unit configured to receives the request for re-execution of the application from the mobile code execution server,
wherein the mobile code is executed as an agent.

9. (canceled)

10. The apparatus as claimed in claim 8, wherein with regard to the mobile code, an ID of the mobile device that transmits the mobile code, and an ID of a mobile application that creates the agent are transmitted together from the mobile device to the mobile code execution server.

11. The apparatus as claimed in claim 8, wherein the mobile code allows the mobile code execution server to generate a small file from a large file located in a cloud storage on behalf of the mobile device.

12. The apparatus as claimed in claim 8, wherein the mobile code allows the mobile code execution server to provide a location based service on behalf of the mobile device.

13. The apparatus as claimed in claim 8, wherein the mobile code allows the mobile code execution server to be executed as a background to thereby perform a monitoring operation on behalf of the mobile device.

14. The apparatus as claimed in claim 8, wherein the mobile code allows the mobile code execution server to perform a contents based search and extraction of a characteristic value on behalf of the mobile device.

15. A method, executed in a mobile code execution server, of providing a cloud service, the method comprising:
receiving a mobile code from a mobile device;
executing the mobile code;
transmitting a request for a service to a cloud server based on the result of the execution of the mobile code;
receiving a result of the service from the cloud server;
transmitting a request for re-execution of a mobile application to the mobile device; and
transmitting the result of the service to the mobile device, wherein the mobile code is executed as an agent.

16. The method as claimed in claim 15, wherein with regard to the mobile code, an ID of the mobile device that transmits the mobile code, and an ID of an mobile application that creates the agent are transmitted together from the mobile device to the mobile code execution server.

17. The method as claimed in claim 15, wherein the mobile code allows the mobile code execution server to generate a small file from a large file located in a cloud storage on behalf of the mobile device.

18. The method as claimed in claim 15, wherein the mobile code allows the mobile code execution server to provide a location based service on behalf of the mobile device.

19. The method as claimed in claim 15, wherein the mobile code allows the mobile code execution server to be executed as a background to thereby perform a monitoring operation on behalf of the mobile device.

20. The method as claimed in claim 15, wherein the mobile code allows the mobile code execution server to perform a contents based search and extraction of a characteristic value on behalf of the mobile device.

21. An apparatus, in a mobile code execution server, for providing a cloud service, the apparatus comprising:
a receiving unit that receives a mobile code from a mobile device, and receives a result of a requested service from a cloud server;
a controller that executes the mobile code; and
a transmission unit that transmits a request for a service to the cloud server, and transmits a request for re-execution of a mobile application to the mobile device, and transmits the result of the service to the mobile device,
wherein the mobile code is executed as agent.

22. The apparatus as claimed in claim 21, wherein with regard to the mobile code, an ID of the mobile device that transmits the mobile code, and an ID of a mobile application that creates the agent are transmitted together from the mobile device to the mobile code execution server.

23. The apparatus as claimed in claim 21, wherein the mobile code allows the mobile code execution server to generate a small file from a large file located in a cloud storage on behalf of the mobile device.

24. The apparatus as claimed in claim 21, wherein the mobile code allows the mobile code execution server to provide a location based service on behalf of the mobile device.

25. The apparatus as claimed in claim 21, wherein the mobile code allows the mobile code execution server to be executed as a background to thereby perform a monitoring operation on behalf of the mobile device.

26. The apparatus as claimed in claim 21, wherein the mobile code allows the mobile code execution server to perform a contents based search and extraction of a characteristic value on behalf of the mobile device.
